(19) United States
(12) Patent Application Publication
(10) Pub. No.: US 2024/0393539 A1
(43) Pub. Date: Nov. 28, 2024

(54) FIBER COLLIMATOR WITH FRESNEL LENS

(71) Applicant: Fuzhou Photop Optics Co., Ltd, Fuxhou (CN)

(72) Inventors: Xiangyu SUN, Fuzhou (CN); Youyuan ZHOU, Fuzhou (CN); Yajuan HU, Fuzhou (CN); Hailiang ZHANG, Fuzhou (CN)

(21) Appl. No.: 18/637,813

(22) Filed: Apr. 17, 2024

(30) Foreign Application Priority Data
May 25, 2023 (CN) 2023106019301

(51) Int. Cl. G02B 6/32; G02B 1/11; G02B 3/08

(52) U.S. Cl. CPC G02B 6/327; G02B 1/11; G02B 3/08

(57) ABSTRACT

The present disclosure provides an optical fiber collimator structure employing a Fresnel lens. An example optical fiber collimator includes an optical fiber to transmit optical signals, the optical fiber being aligned with a central axis of the optical fiber collimator. A capillary supports the optical fiber. A support element receives the optical fiber as it enters the optical fiber collimator. A Fresnel lens is aligned with the optical fiber and configured to receive the optical signals from the optical fiber.

### BACKGROUND OF THE DISCLOSURE

Collimators have become an important component for modern fiber transmission systems. They may be incorporated at interfaces between components, such as fiber connections, as well as providing an input or output for an optical fiber at a signal source, device, etc.

Convention is to use a C-lens type optical lens. This may work, but there are always limits on the smallest size that a fiber coupling can be, and may be limited to a narrow band of wavelengths. As the size of couplings and/or collimators remains high, the overall size of devices in which the components are used remains quite large. In addition, costs will be higher for larger and more complex optical components.

The subject matter of the present disclosure is directed to overcoming, or at least reducing the effects of, one or more of the problems set forth above.

### SUMMARY OF THE DISCLOSURE

According to the present disclosure, an optical fiber collimator includes an optical fiber supported by a capillary. The optical fiber collimator includes an integrated Fresnel lens aligned with the optical fiber, the Fresnel lens configured to transmit the optical signals to, and/or receive the optical signals from, the optical fiber.

The foregoing summary is not intended to summarize each potential embodiment or every aspect of the present disclosure.

### BRIEF DESCRIPTION OF THE DRAWINGS

FIG. 1A illustrates an example optical fiber collimator incorporating a Fresnel lens, according to the present disclosure.

FIG. 1B illustrates an example Fresnel lens, according to the present disclosure.

FIG. 2A illustrates a plan view of an example Fresnel lens, according to the present disclosure.

FIG. 2B illustrates a plan view of another example Fresnel lens, according to the present disclosure.

FIGS. 3A and 3B illustrate example applications for an optical fiber collimator, according to the present disclosure.

The figures are not necessarily to scale. Where appropriate, similar or identical reference numbers are used to refer to similar or identical components.

### DETAILED DESCRIPTION OF THE DISCLOSURE

The following discussion presents various aspects of the present disclosure by providing examples thereof. Such examples are non-limiting, and thus the scope of various aspects of the present disclosure should not necessarily be limited by any particular characteristics of the provided examples. In the following discussion, the phrases “for example,” “e.g.,” and “exemplary” are non-limiting and are generally synonymous with “by way of example and not limitation,” “for example and not limitation,” and the like.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.”

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example a semiconductor device or package may be turned sideways so that its “top” surface is facing horizontally and its “side” surface is facing vertically, without departing from the teachings of the present disclosure.

In the drawings, the thickness or size of layers, regions, and/or components may be exaggerated for clarity. Accordingly, the scope of this disclosure should not be limited by such thickness or size. Additionally, in the drawings, like reference numerals may refer to like elements throughout the discussion. Elements numbered with an apostrophe (′) can be similar to correspondingly numbered elements without an apostrophe.

It will also be understood that when an element A is referred to as being “connected to” or “coupled to” an element B, the element A can be directly connected to the element B or indirectly connected to the element B (e.g., an intervening element C (and/or other elements) may be present between the element A and the element B).

Optical fiber collimators have become an important input and/or output optical element, widely used in the field of optical communications and/or laser transmission, for example. The function of optical fiber collimators is to couple fibers with devices receiving light as an input (or transmitting light as an output) with maximum efficiency. As a result, light is input and/or output as approximately parallel Gaussian beams.

There are a number of different collimator types employed to transmit optical signals. An example is a C-lens type optical lens, defined by spherical characteristics at one end, and as a gradient index (GRIN) lens at another end, such as with natural/inherent focusing characteristics. This type of lens may have a size of about 1 mm to 2 mm at an outer diameter. However, this size makes it difficult to miniaturize the lens for incorporation in a small device. Further, such lenses are often formed by an optical grinding processing, through which miniaturization is quite difficult, and creates limitations for mass production of the lenses.

In disclosed examples, a Fresnel lens is employed with an optical collimator. Also known as a screw lens, Fresnel lenses can be formed of a variety of materials (e.g., plastics, polymers, composites, glass, etc.). A Fresnel lens may be characterized as having one end with a substantially smooth surface, with another (often opposite) side of the lens formed of or recorded with concentric circles from small to large about a central axis. Advantageously, Fresnel lenses can be mass produced by one or more formation techniques. For example, Fresnel lenses can be molded, such as when accuracy requirements provide some flexibility. Fresnel lenses can also be formed via one or more micro optical processing technologies, such as lithography and/or relief, when tolerance levels require greater accuracy. In some examples, a Fresnel lens(es) may be formed directly on the end of a surface of the optical fiber, rather than a component fixed to an end of the optical fiber.

Turning to the figures, an optical fiber collimator structure incorporating a Fresnel lens with a compact design, low cost of formation, capable of mass production via a high-precision formation process is provided.

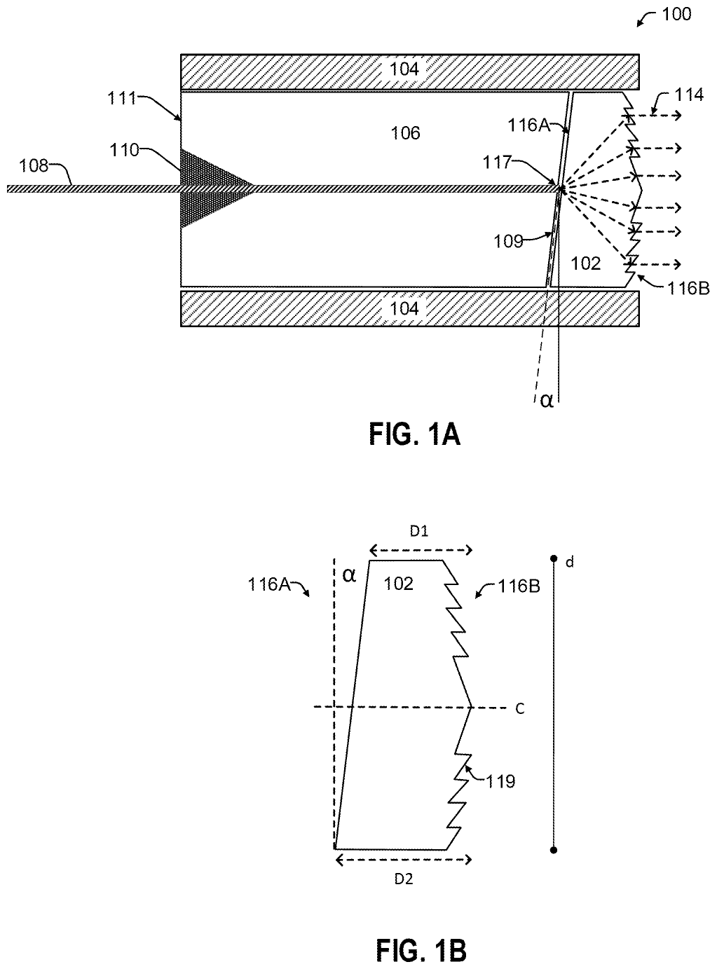

As illustrated in the example of FIG. 1A, an optical fiber collimator structure 100 employs one or more of a Fresnel lens 102, an optical fiber 108, and a capillary 106. The optical fiber 108 is fixed in the capillary 106 to form the optical fiber collimator. The components of the optical fiber collimator 100 can be fixed within an axial pipe or sleeve 104.

A first end 116A of the Fresnel lens 102 is arranged to receive optical signals from an output facet 117 of the optical fiber 108. In some examples, one or more optical elements, such as one or more lenses, filters, etc., may be positioned between the output facet 117 and the first end 116A. Various types of optical couplings can be used.

As shown in the figure, the first end 116A is defined by a wedge angle α relative to a central axis of the Fresnel lens (e.g., central axis C shown in FIG. 1B). To achieve the desired angle, the Fresnel lens can be formed, ground, and/or polished to yield the angle α (e.g., of approximately 8 degrees). A surface 109 of the capillary 106 is defined by an angle complimentary to α, such that the surface 109 is configured to mate with the first surface 116A of the Fresnel lens 102.

In some examples, one or more surfaces of the Fresnel lens 102 are coated with antireflective (AR) coatings. Depending on the desired implementation, antireflective (AR) coatings can be applied at one or more interfaces along the optical path. For instance, an AR coating can be applied at end facets of the optical fiber (e.g., facet 117) and/or on one or more surfaces or ends 116A, 116B of the Fresnel lens 102. In other words, all or a portion of first and/or second surface can have an AR coating applied. A given AR coating can be selected from a range of reflectivity values. Moreover, different surfaces may have the same AR coatings and/or values, or may have different AR coatings and/or values. The reflectivity of the coatings may be or include reflectivity for a single wavelength, multiple wavelengths, or a range of wavelengths, depending on operational needs of an associated device. Such values can be varied depending on the implementation.

As optical signals 114 from the optical fiber 108 traverse the Fresnel lens 102, they spread out based on a number of characteristics and/or factors, including the lens' index of refraction, various dimensions, location and size of the concentric circles of the lens, as well as the wavelength of the optical signals 114. In the illustrated example, the optical signals 114 are transmitted from second surface 116B to be distributed but substantially parallel. However, the characteristics and/or factors defining the interaction between the lens and optical signals control the power distribution of the resulting signals. For instance, a generally bell shaped output may be suitable for a variety of applications.

FIG. 1B illustrates a detailed view of example Fresnel lens 102. A Fresnel lens is a type of compact lens that incorporates multiple output surfaces on the second surface 116B (e.g., corresponding to one or more concentric, annular sections or circles 119) to focus transmitted signals. In operation, a Fresnel lens is capable of producing a focused output with less material and in a more compact envelope in comparison to a conventional lens with similar power. For instance, each concentric circle 119 serves to limit an overall thickness of the lens, in comparison to conventional lenses. The design features of a Fresnel lens therefore allows a substantial reduction in overall lens thickness, and the associated mass, amount of material used, etc.

In some examples, the first surface 116A is substantially planar, the plane being orientated at angle α relative to a plane perpendicular to the central axis C. In some examples, the angle is greater than or less than the angle α, and may be perpendicular to the central axis C. In some examples, the second surface 116B is defined as a substantially curved surface, such that the concentric circles 119 extend from second surface 116A by a smaller amount at edges of the lens than at the center. The angle α may be selected from a range of values. For instance, the angle α can range from about 6 degrees to about 10 degrees, as a non-limiting example range. Here, the angle is measured from a plane perpendicular to central axis C. Moreover, one or more of the optical fiber 108, the support 110, the capillary 106, and/or the sleeve 104 can be coaxial with the central axis C.

As shown in the example of FIG. 1B, an example Fresnel lens 102 can be dimensioned with a first depth D1 at a first side and a second depth D2 at a second side. The difference in relative depth is due to the angle α of the surface 116A. Thus, as the angle changes, the difference in depth between D1 and D2 will change. The diameter d of the Fresnel lens can range from about 1.0 mm to 2.0 mm in some examples, and may be up to or greater than 10.0 mm, depending on a particular application.

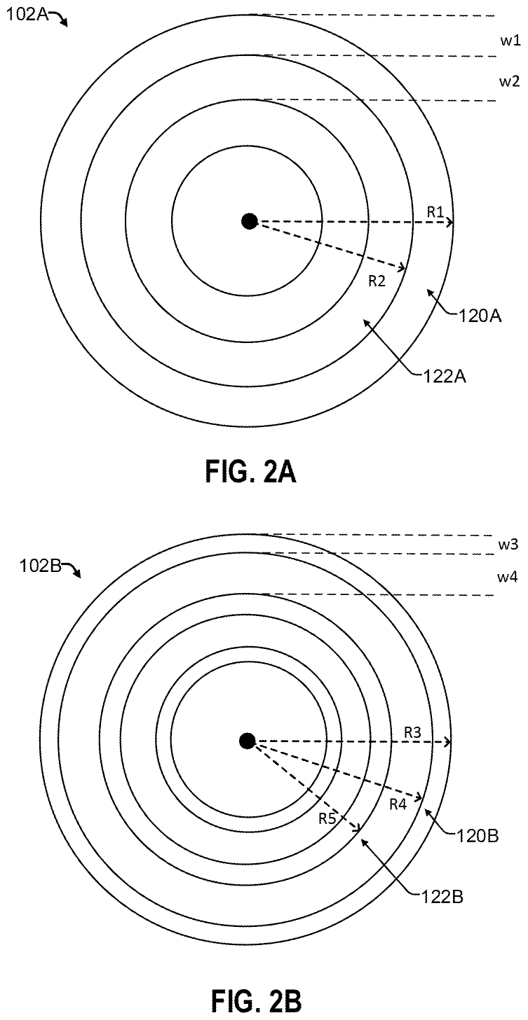

FIGS. 2A and 2B provide example Fresnel lenses with a number of concentric circles, shown on a first surface of the Fresnel lenses. Power distribution of the light signal 114 can be changed by changing the lens within the structure. In the example of FIG. 2A, a Fresnel lens 102A has concentric circles 120A and 122A with widths of w1 and w2, respectively. For instance, the widths of both w1 and w2 can be measured as the radius R1 less the radius R2. As shown, widths w1 and w2 are substantially the same, and would produce a first power distribution of the light signal 114.

In the example of FIG. 2B, a Fresnel lens 102B has concentric circles 120B and 122B with widths of w3 and w4, respectively. As shown, widths w3 and w4 are different. For instance, width w3 of circle 120B is equivalent to radius R3 less radius R4, whereas width w4 of circle 122B is equivalent to radius R4 less radius R5. As a result, Fresnel lens 102B would produce a second power distribution of the light signal 114 different from the first power distribution.

Although the number of circles and/or their widths can vary between lenses, the Fresnel lenses are operable over a wide variety of wavelengths, often regardless of such features.

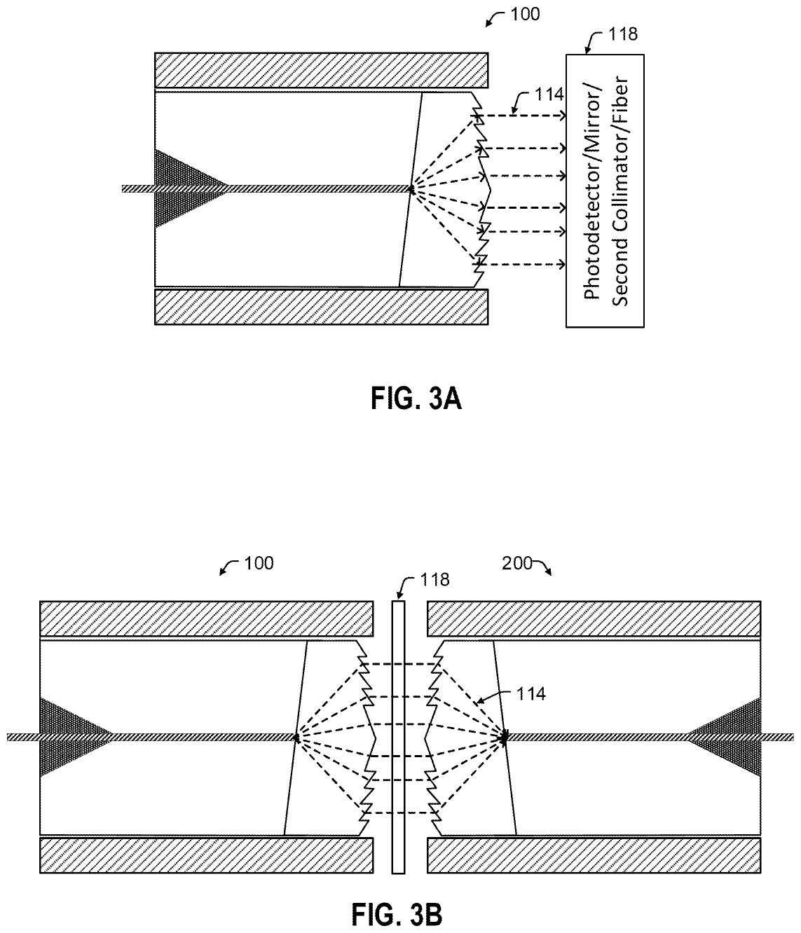

FIGS. 3A and 3B illustrate example applications for the disclosed optical fiber collimator. As shown in the example of FIG. 3A, the optical fiber collimator 100 can be coupled to one or more optical elements 118, which are configured to send or receive optical signals. For example, the optical fiber collimator 100 can transmit collimated light 114 to the optical element, such as a photodetector, an optical lens, a mirror, a filter, a Bragg grating, and/or a second optical fiber, as a list of non-limiting examples.

In some examples, as shown in FIG. 3B, a second optical fiber collimator 200 can be coupled to the optical fiber collimator 100. For instance, both optical fiber collimators 100 and 200 can receive/transmit signals via optional optical element 118, and/or the optical fiber collimators 100 and 200 can receive/transmit signals directly to or from one another.

In disclosed examples, an optical fiber collimator includes an optical fiber to transmit optical signals. A capillary supports the optical fiber. And a Fresnel lens is aligned with the optical fiber and to receive the optical signals.

In some examples, a first end of the Fresnel lens is arranged to receive the optical signals from an output facet of the optical fiber, the first end being defined by an angle relative to a central axis of the Fresnel lens.

In examples, the first end is substantially planar. In examples, one or more of the optical fiber and capillary are aligned with the central axis. In examples, the Fresnel lens further comprises a second end opposite the first end, the second end being defined by a plurality of concentric circles. In examples, each of the plurality of concentric circles have a common width. In examples, a first concentric circle of the plurality of concentric circles has a first width different from a second width of a second concentric circle of the plurality of concentric circles.

In some examples, the Fresnel lens has a first depth at a first side and a second depth at a second side.

In some examples, an antireflective coating is applied on one or more surfaces of the Fresnel lens. In examples, an output facet of the optical fiber comprises an antireflective coating, the output configured to transmit the optical signal to the Fresnel lens.

In some disclosed examples, an optical fiber collimator includes an optical fiber to transmit optical signals, the optical fiber aligned with a central axis of the optical fiber collimator. A capillary supports the optical fiber. A support element receives the optical fiber as it enters the optical fiber collimator. And a Fresnel lens aligned with the optical fiber and to receive the optical signals.

In some examples, the optical fiber collimator is coupled to one or more optical elements. In examples, the optical element is one or more of a photodetector, an optical lens, a mirror, a filter, a Bragg grating, a second collimator, or a second optical fiber.

In some examples, an antireflective coating may be on one or more surfaces of the Fresnel lens. In examples, a first surface of the Fresnel lens has a first antireflective coating and a second surface of the Fresnel lens has a second antireflective coating. In examples, the first surface of the Fresnel lens is defined by an angle relative to the central axis. In examples, a surface of the capillary is defined by the angle, the surface of the capillary configured to mate with the first surface of the Fresnel lens.

In some examples, the optical fiber collimator is substantially cylindrical.

In some examples, a sleeve may be around an outer surface of the capillary. In examples, a position or orientation of the Fresnel lens is fixed relative to one or more of the optical fiber, the capillary, the sleeve, or the support element.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

1. An optical fiber collimator comprising:
an optical fiber to transmit optical signals;
a capillary to support the optical fiber; and
a Fresnel lens aligned with the optical fiber and to receive the optical signals.

2. The optical fiber collimator of claim 1, wherein a first end of the Fresnel lens is arranged to receive the optical signals from an output facet of the optical fiber, the first end being defined by an angle relative to a central axis of the Fresnel lens.

3. The optical fiber collimator of claim 2, wherein the first end is substantially planar.

4. The optical fiber collimator of claim 2, wherein one or more of the optical fiber and capillary are aligned with the central axis.

5. The optical fiber collimator of claim 2, wherein the Fresnel lens further comprises a second end opposite the first end, the second end being defined by a plurality of concentric circles.

6. The optical fiber collimator of claim 5, wherein each of the plurality of concentric circles have a common width.

7. The optical fiber collimator of claim 5, wherein a first concentric circle of the plurality of concentric circles has a first width different from a second width of a second concentric circle of the plurality of concentric circles.

8. The optical fiber collimator of claim 1, wherein the Fresnel lens has a first depth at a first side and a second depth at a second side.

9. The optical fiber collimator of claim 1, further comprising an antireflective coating on one or more surfaces of the Fresnel lens.

10. The optical fiber collimator of claim 9, wherein an output facet of the optical fiber comprises an antireflective coating, the output configured to transmit the optical signal to the Fresnel lens.

11. An optical fiber collimator comprising:
an optical fiber to transmit optical signals, the optical fiber aligned with a central axis of the optical fiber collimator;
a capillary to support the optical fiber;
a support element to receive the optical fiber as it enters the optical fiber collimator; and
a Fresnel lens aligned with the optical fiber and to receive the optical signals.

12. The optical fiber collimator of claim 1, wherein the optical fiber collimator is coupled to one or more optical elements.

13. The optical fiber collimator of claim 12, wherein the optical element is one or more of a photodetector, an optical lens, a mirror, a filter, a Bragg grating, a second collimator, or a second optical fiber.

14. The optical fiber collimator of claim 11, further comprising an antireflective coating on one or more surfaces of the Fresnel lens.

15. The optical fiber collimator of claim 14, wherein a first surface of the Fresnel lens has a first antireflective coating and a second surface of the Fresnel lens has a second antireflective coating.

16. The optical fiber collimator of claim 15, wherein the first surface of the Fresnel lens is defined by an angle relative to the central axis.

17. The optical fiber collimator of claim 16, wherein a surface of the capillary is defined by the angle, the surface of the capillary configured to mate with the first surface of the Fresnel lens.

18. The optical fiber collimator of claim 11, wherein the optical fiber collimator is substantially cylindrical.

19. The optical fiber collimator of claim 11, further comprising a sleeve around an outer surface of the capillary.

20. The optical fiber collimator of claim 19, wherein a position or orientation of the Fresnel lens is fixed relative to one or more of the optical fiber, the capillary, the sleeve, or the support element.
